(19) United States
(12) Patent Application Publication
(10) Pub. No.: US 2023/0024536 A1
(43) Pub. Date: Jan. 26, 2023

(54) Bi-Directional Roller Corrugating Tool Holder

(71) Applicant: Regency Mill Services LLP, Amarillo, TX (US)

(72) Inventor: Thomas Ryan Gerber, Amarillo, TX (US)

(21) Appl. No.: 17/858,937

(22) Filed: Jul. 6, 2022

Related U.S. Application Data
(60) Provisional application No. 63/224,355, filed on Jul. 21, 2021.

(51) Int. Cl. B23B 27/16

(52) U.S. Cl. CPC B23B 27/16

(57) ABSTRACT

A cutter insert tool holder effects bidirectional linear cuts on a work surface. The tool holder includes two elongated slots sized to accommodate first and second cutting insert holders. The tool holder includes an actuator arm that is placed in a first pivoting position by contacting the work surface while the tool holder is displaced along the work surface in a first direction, the pivoting actuator arm causes an actuator cam to contact and engage the second cutting insert holder so that it is withdrawn while the first cutting insert forms a cut in the work surface. When the tool holder is displaced along the work surface in a second direction opposite the first direction, the pivoting actuator arm causes the actuator cam to contact and engage the first cutting insert holder so that it is withdrawn while the second cutting insert forms a cut in the work surface.

### RELATED APPLICATION

This application claims the benefit of U.S. Provisional Patent Application No. 63/224,355 filed on Jul. 21, 2021, the entirety of which is incorporated herein for reference.

### FIELD

The present disclosure relates to cutter insert tool holder, and more particularly to a tool holder for use with a computer numerical control (CNC) machine so that corrugation grooves may be efficiently and bidirectionally machined on a roller.

### BACKGROUND

Chilled cast iron rolls used in milling materials such as flour, oilseed, coffee, animal feed, or chocolates are fabricated by forming corrugation on the roller blanks according to customer specifications. In producing animal feed, for example, steam-flaked, cracked corn, and other coarse-textured feed, is milled from grains. “Flake” is achieved when grain is heated, typically by the introduction of steam or other heating processes, and then flattened between a pair of rollers to attain the desired level of gelatinized starch from each kernel of grain. The roller mill manufacturing industry has relied on the process of grinding and fluting or corrugating rollers to achieve the degree of consistency in the particulate size and flake quality of the grains being processed for feed. The most common style of roll corrugation used for feed milling applications includes a round-bottom vee (RBV) configuration, such as shown in FIG. 4, but the grooves can have any suitable profile. This type of corrugation configuration provides a good grip to pull the product into the rolls while avoiding a sharp edge that might cut the grain. Historically corrugation and re-corrugation of the rolls has been achieved using a single direction cutting process using a multi-tooth built-to-diameter cutting tool to attain the desirable corrugation profile. The conventional single cut process creates the plurality of elongated cuts on the roller's curved surface by cutting each groove in a single direction. The accuracy of the tooth count degrades depending on the change in the roll diameter as the characteristics of the cutting tool never changes.

### BRIEF DESCRIPTION OF THE DRAWINGS

FIG. 1 is an exploded view of an exemplary embodiment of a bidirectional roller corrugation tool holder according to the teachings of the present disclosure;

FIG. 2 is a top plan view of an exemplary embodiment of a partially assembled bidirectional roller corrugation tool holder according to the teachings of the present disclosure;

FIGS. 3A-3C are pictorial illustrations showing the bidirectional operation of the roller corrugation tool holder according to the teachings of the present disclosure;

FIG. 4 are illustrations showing the cross-sectional profiles of corrugation groove examples according to the teachings of the present disclosure; and

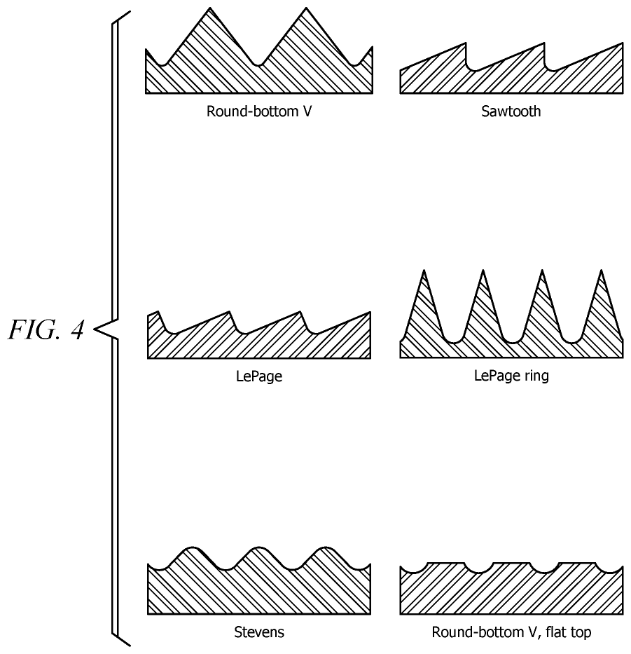

FIG. 5 is a perspective view of an exemplary roll having a plurality of longitudinal corrugation grooves in its curved surface according to the teachings of the present disclosure.

### DETAILED DESCRIPTION

For grain flaking and cracking and crimping applications, the roll corrugations usually have the RBV (round-bottom vee) profile with little or no spiral. Typically, the corrugation are 12-14 grooves per inch (gr/in) for processing corn, 14-16 grooves per inch for processing milo, and 16-18 grooves per inch for crimping other small grains. For steam flaking applications, large-diameter rolls ranging from 18 to 32 inches are used. As in other roller-mill applications, roll corrugations must be selected with a view to the grain(s) to be flaked, product quality desired, and optimizing the life of the corrugation. Compared to finer corrugations, coarser grooving (12-14 gr/in) will have longer life and achieve a higher capacity but may not produce the desired flake thickness and quality. Finer corrugations (18 to 20 gr/in) produce thinner, more uniform flakes but cannot maintain the capacity of coarser corrugations and will require roll re-corrugation more often.

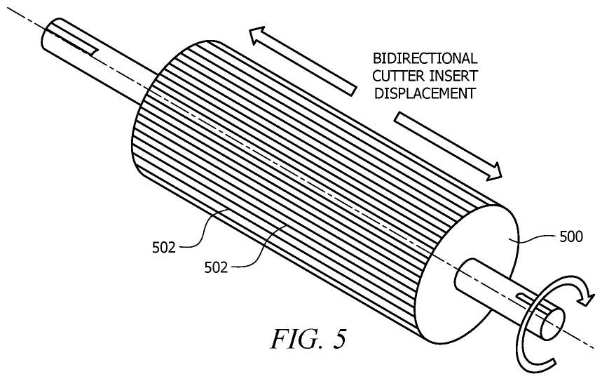

Numerical control or computer numerical control (CNC) machines are computer automated tools that may be programed to have precise movement of a tool and the work piece to fabricate the corrugation grooves on the curved surface of the roller blanks used in roller mill applications, such as shown in FIG. 5. Conventional corrugation processes involve cutting the grooves on the work surface of the roller blank only in a single direction. The cutting tool then travels back to the original position and performs the next cut on the repositioned work piece. This single-direction corrugation cutting process is time-consuming, taking up to twenty hours to fabricate two 24-inch by 48-inch rolls.

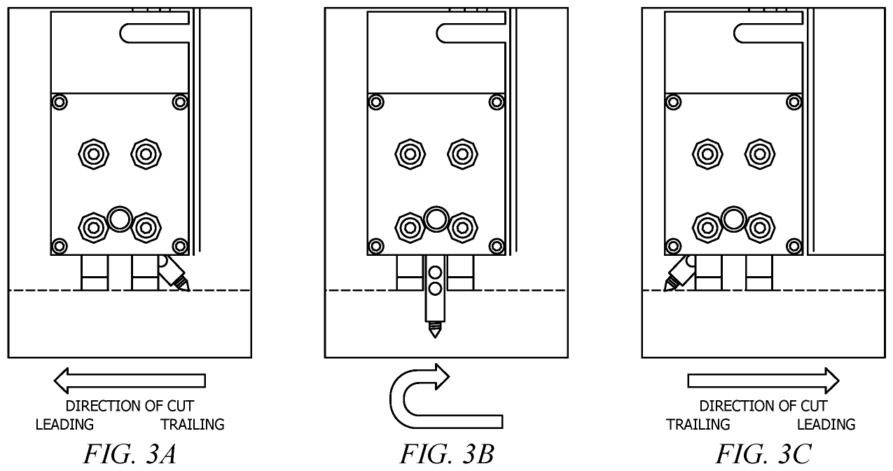

The bidirectional, single-point roller corrugation tool holder described herein enables the roll corrugation fabrication to be done in a much more efficient manner, resulting in a 40-60% time savings. The tool holder holds two cutting inserts, with the cutting insert in the leading position according to the direction of travel cutting a groove on the work surface while the trailing cutting insert is recessed automatically so it does not contact the work surface. When the tool holder is traveling in the opposite direction, the roles of the cutting inserts switch automatically, and the now leading cutting insert cuts a new groove on the work surface while the now trailing cutting insert is recessed automatically. This bidirectional cutting operation of the tool holder is illustrated in FIGS. 3A-3C and described in more detail below.

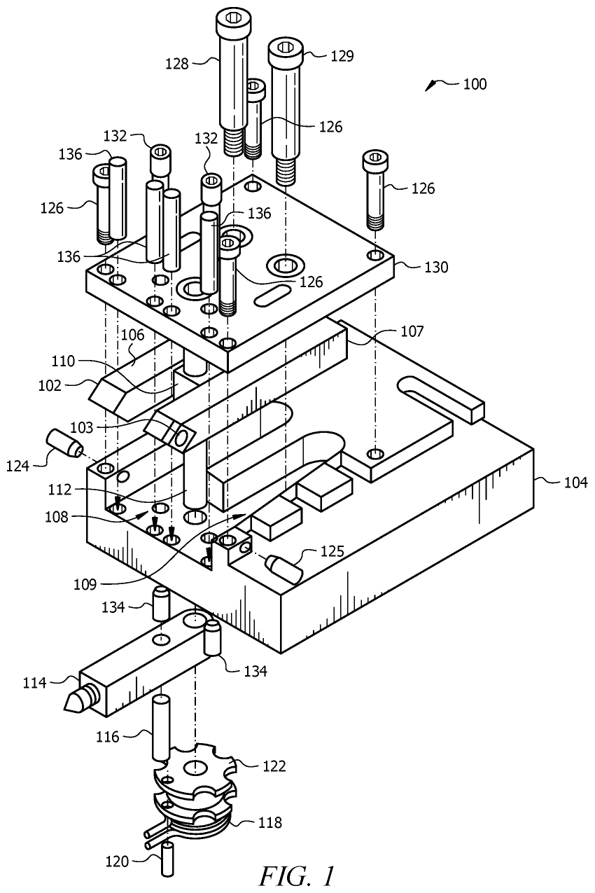

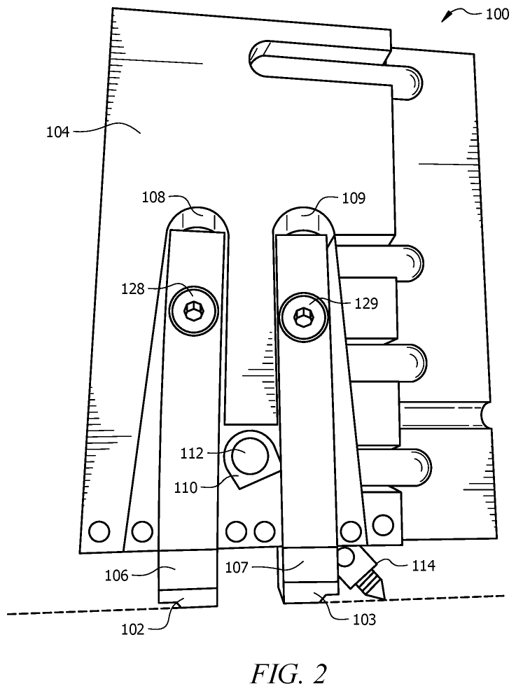

Referring to FIGS. 1 and 2, the bidirectional roller corrugation tool holder 100 that securely holds two cutter inserts 102 and 103 for use with a CNC lathe (not shown). The tool holder 100 includes a holder body 104 that functions as an interface to a wedge clamp system or another suitable device that serves to securely mount the tool holder 100 to a moving component (commonly called the tool turret) of the CNC lathe. The CNC lathe is programed to precisely position and move the cutter inserts 102 and 103 securely held by the tool holder 100 along the curved surface of a chilled cast iron roll 500 held in the chuck of the CNC lathe. As shown in FIG. 5, the slide of the CNC machine automatically moves the tool holder 100 along a line parallel to the longitudinal center axis of the roll 500 in a first direction from one end of the roll to the other end of the roll so that the first cutter insert 102 cuts a longitudinal groove 502 on the curved surface of the roll 500, then the chuck automatically rotates the roll by a predetermined angle to reposition the roll 500 for the next pass of the second cutter insert 103. The slide then automatically moves the tool holder 100 along a line parallel to the longitudinal center axis of the roll 500 in a second direction opposite of the first direction so that the second cutter insert 103 cuts a second longitudinal groove 502 on the work surface of the roll 500 adjacent to the previous cut. The CNC lathe is programed to automatically and precisely move the tool holder 100 bidirectionally and automatically rotate the roll 500 by a predetermined amount (degrees) to form a plurality of corrugated parallel longitudinal grooves 502 on the curved surface of the roll 500 around its entire circumference.

The bidirectional roller corrugation tool holder 100 holds two elongated cutting insert holders 104 and 105 each securely holding a cutting insert 102 and 103 that are in general linear alignment with one another. The cutting inserts 102 and 103 are positioned within the holders 106 and 107 so that their respective cutting edges face away from each other. The cutting inserts 102 and 103 may be fabricated of any suitable material such as solid cubic boron nitride (CBN) and have a suitable shape to achieve the desired corrugation groove profile. The cutting insert holders 106 and 107 are each disposed within an elongated slot 108 and 109 defined within a tool holder body 104 fabricated from a block of metal having desired hardness and other properties, such as 4140 steel. The cutting insert holders 106 and 107 are pivotally positioned and secured within the slots 108 and 109 so that the cutting inserts 102 and 103 extend beyond the tool holder body 104. The dimensions and/or shape of the slots 108 and 109 are such that the cutting insert holders 106 and 107 can move slightly to change the length of the cutting insert holder 106 and 107 that protrude beyond the tool holder body 104. An actuator cam 110 is pivotally secured to the tool holder body 104 by an actuator shaft 112. The actuator cam 110 is disposed between the cutting inert holder slots 108 and 109 so that the cutting insert holders 106 and 107 alternately contact and engage the actuator cam 110 when the actuator cam 110 alternately rotates between two positions. The actuator cam 110 and actuator shaft 112 are coupled to an actuator arm 114 that extends beyond the tool holder body 104. The actuator arm 114 is coupled to the actuator shaft 112 so that the pivotal motion of the actuator arm 114 is translated to the rotational motion of the actuator shaft 112 and transferred to the rotational motion of the actuator cam 110. The rotational motion of the actuator cam 110 between the first position and the second position causes the first and second cutting inserts to alternately withdraw slightly into the slots. In other words, when the actuator arm 114 is in the first position, the first cutting insert is withdrawn slightly, and when the actuator arm 114 is in the second position, the second cutting insert is withdrawn slightly. A first pin 116 and a cam actuator spring 118 are attached to the actuator arm 114, and a second pin 120 is attached to a cam actuator 122 so that the actuator arm 114 is biased to maintain a neutral or substantially vertical position when secured to the slide of the CNC machine and positioned above a work piece. Spring plungers 124 and 125 are coupled to the tool holder body 104 but extend through openings to the elongated slots 108 and 109 respectively to provide slight pressure to urge the cutting insert holders 106 and 107 from their recessed positions to their cutting or working positions when the tool holder travel direction changes. As shown in FIG. 1, a cover plate 130 is affixed to the tool holder body 104 to retain and protect the cutting insert holders 106 and 107. The cutter inserts 106 and 107 are further held in place within the slots by pivot bolts 128 and 129. A number of retaining screws 126 are used to secure the cover plate 118 to the holder body 104 and retain the cutter insert holders 106 and 107 within the slots 108 and 109. Further, a number of top and bottom spring plungers 132 and 134 provide minute adjustments to the cutting insert holders 106 and 107 in a side-to-side direction. Four hardened pins 136 are positioned on either side of the elongated slots 108 and 109 to provide the stops for the cutting insert holders 106 and 107 when they pivot between the cutting and recessed positions.

Configured and constructed in this manner, the actuator arm 114 may pivot between two positions. The actuator arm 114, when in a first position, causes the actuator shaft 112 to rotate and the actuator cam 110 to contact the first cutting insert holders and lift it up slightly so that the cutting insert it holds is withdrawn slightly from the cutting surface. Similarly, when the actuator arm 114 swings to the second position, it causes the actuator shaft 112 to rotate in the other direction and the actuator cam 110 contacts the second cutting insert holder, which lifts up the second cutting insert slightly so that it is withdrawn slightly from the cutting surface. Operating in this manner, the trailing cutter insert is always lifted up and away from the roller surface no matter which direction the CNC slide is traveling. The trailing cutter insert is the cutter insert facing away from the direction that the CNC slide is traveling.

As shown in FIGS. 3A-3C, the tool holder is securely attached to a slide of the CNC machine and is moved longitudinally along the roller in a first direction where a corrugation groove is formed by the cutting insert in the leading position. As shown in FIG. 3A, the actuator arm is pivoted away from the direction of the cutting movement due to its contact with the work surface and the direction of travel. The amount of movement of the leading cutting insert holder within its slot caused by the rotation of the actuator cam due to the position of the actuator arm is sufficient to lift the trailing cutting insert off of the roll surface while the leading cutting insert is cutting the corrugation groove. The trailing cutting insert is therefore automatically recessed and does not contact the work surface. As shown in FIG. 3B, when the slide reaches the end of the roll and travels beyond the end of the roll, the actuator arm is allowed pivot to its neutral (vertical) position (with help from the biasing spring). The CNC machine then precisely rotates the roller blank by a predetermined number of degrees to position it for the next cut. When the tool holder is moved back to the end of the roll in the opposite direction, and the now leading cutting insert begins to contact and cut the next corrugation groove, the actuator arm contacts the work surface of the roll and pivots to the second position. This in turn causes the actuator cam to rotate and contact the now trailing cutting insert holder and lifts the trailing cutting insert off of the work surface of the roll, as shown in FIG. 3C. In this way, corrugated grooves are formed on the work surface of the roll by both cutting inserts alternately moving in both directions. Because the non-working cutting insert is recessed and lifted from the work surface of the roll, the cutting inserts may remain in service much longer. Further, because the corrugation grooves are cut when the slide makes passes over the roll in both directions, the amount of fabrication time for each roll is drastically reduced.

It should be noted that the tool holder 100 contemplated and described herein can be used to hold any type of cutter insert for creating any type of linear or non-linear cut on a blank in a bidirectional manner. The tool holder 100 is operable to automatically slightly withdraw the inactive cutter insert while cutting in one direction and automatically switch to slightly withdraw the other cutter insert while cutting in the other direction.

The features of the present invention which are believed to be novel are set forth below with particularity in the appended claims. However, modifications, variations, and changes to the exemplary embodiments of a bidirectional flaker-corrugating tool holder described above will be apparent to those skilled in the art, and the described herein thus encompasses such modifications, variations, and changes and are not limited to the specific embodiments described herein.

What is claimed is:

1. A cutter insert tool holder for use with a computer numerical control lathe programed to effect linear displacement of a slide along a work surface of a cylindrical roll, comprising:
a tool holder body;
first and second elongated cutting insert holders configured for securely holding first and second cutting inserts at respective first ends;
first and second elongated slots defined in the tool holder body sized to accommodate the first and second elongated cutting insert holders so that the first and second cutting inserts extend beyond the tool holder body and in substantially linear alignment with one another;
an actuator cam secured to the tool holder body by an actuator shaft, the actuator cam having a first pivoting position where it contacts and withdraws the first cutting insert holder within the first elongated slot, and a second pivoting position where it contacts and withdraws the second cutting insert holder within the second elongated slot;
an actuator arm coupled to the actuator shaft and the tool holder body, the actuator arm being placed in a first pivoting position by contacting the work surface of the cylindrical roll while the tool holder is being displaced along the work surface in a first direction, the pivoting actuator arm causing the actuator cam to contact and engage the second cutting insert holder so that the second cutting insert is withdrawn from contacting the work surface, and the first cutting insert is operable to form a cut in the work surface of the cylindrical roll; and
the actuator arm being placed in a second pivoting position by contacting the work surface of the cylindrical roll while the tool holder is being displaced along the work surface in a second direction opposite the first direction, and the second cutting insert is operable to form a cut in the work surface of the cylindrical roll, while the pivoting actuator arm causing the actuator cam to contact and engage the first cutting insert holder so that the first cutting insert is withdrawn from contacting the work surface.

2. The tool holder in claim 1, further comprising a cover plate enclosing and retaining the first and second cutting insert holders within the first and second elongated slots.

3. The tool holder in claim 1, further comprising a spring coupled to the actuator arm configured to bias the actuator arm to maintain a neutral position between the first and second pivoting positions.

4. The tool holder in claim 1, wherein the first and second elongated cutting insert holders are pivotally secured to the tool holder body within the first and second elongated slots using first and second pivot bolts and pivot bushings.

5. The tool holder in claim 1, further comprising first and second spring plungers disposed adjacent to the first and second elongated cutting insert holders operable to urge the first and second elongated cutting insert holders to return from their respective pivoted withdrawn positions to respective cutting positions.

6. The tool holder in claim 1, further comprising hardened stops disposed adjacent to the first and second elongated slots on either side of each of the first and second cutting insert holders.

7. The tool holder in claim 1, further comprising means to make minute adjustments to the position of the first and second cutting insert holders within the elongated slots.

8. A cutter insert tool holder for use with a computer numerical controlled lathe programed to effect displacement of a slide along a work surface of a work piece, comprising:
a tool holder body having an interface configured for secure attachment to the slide;
first and second elongated slots defined in the tool holder body arranged substantially parallel with one another;
first and second elongated cutting insert holders being pivotally secured within the first and second elongated slots so that a first end of each cutting insert holder extends beyond the tool holder body;
an actuator cam secured to the tool holder body by an actuator shaft, the actuator cam having a first pivoting position where it contacts and withdraws the first cutting insert holder within the first elongated slot, and a second pivoting position where it contacts and withdraws the second cutting insert holder within the second elongated slot;
an actuator arm coupled to the actuator shaft and the tool holder body, the actuator arm being biased to maintain a neutral position;
the actuator arm being displaced from the neutral position to a first pivoting position by contacting the work surface of the work piece while the tool holder is being displaced along the work surface in a first direction and the first cutting insert is cutting a groove on the work surface, the actuator arm in the first pivoting position causing the actuator cam to contact and withdraw the second cutting insert holder and cutting insert from contacting the work surface; and
the actuator arm being displaced from the neutral position to a second pivoting position by contacting the work surface of the work piece while the tool holder is being displaced along the work surface in a second direction opposite of the first direction and the second cutting insert is cutting another groove on the work surface, the pivoting actuator arm causing the actuator cam to contact and withdraw the first cutting insert holder and cutting insert from contacting the work surface.

9. The tool holder in claim 8, further comprising a cover plate enclosing and retaining the first and second cutting insert holders within the first and second elongated slots.

10. The tool holder in claim 8, further comprising a spring coupled to the actuator arm configured to bias the actuator arm to maintain the neutral position between the first and second pivoting positions.

11. The tool holder in claim 8, wherein the first and second elongated cutting insert holders are pivotally secured to the tool holder body within the first and second elongated slots using first and second pivot bolts and pivot bushings.

12. The tool holder in claim 8, further comprising first and second spring plungers disposed adjacent to the first and second elongated cutting insert holders operable to urge the first and second elongated cutting insert holders to return from their respective pivoted withdrawn positions to respective cutting positions.

13. The tool holder in claim 8, further comprising hardened stops disposed adjacent to the first and second elongated slots on either side of each of the first and second cutting insert holders.

14. The tool holder in claim 8, further comprising means to make minute adjustments to the position of the first and second cutting insert holders within the elongated slots.

15. A cutter tool holder, comprising:
a tool holder body;
first and second elongated slots defined in the tool holder body arranged substantially parallel with one another;
first and second elongated cutting insert holders for securely holding first and second cutting inserts, the cutting insert holders being pivotally secured within the first and second elongated slots so that the first and second cutting inserts extend beyond the tool holder body;
an actuator cam secured to the tool holder body by an actuator shaft, the actuator cam having a first pivoting position where it contacts and withdraws the first cutting insert holder within the first elongated slot, and a second pivoting position where it contacts and withdraws the second cutting insert holder within the second elongated slot;
an actuator arm coupled to the actuator shaft and the tool holder body;
the actuator arm being in a first pivoting position by contacting the work surface while the tool holder is being displaced along the work surface in a first direction, the actuator arm in the first pivoting position causing the actuator cam to rotate and lift the second cutting insert up from contacting the work surface; and
the actuator arm being in a second pivoting position by contacting the work surface while the tool holder is being displaced along the work surface in a second direction opposite of the first direction, the actuator arm in the second pivoting position causing the actuator cam to rotate and lift the first cutting insert up from contacting the work surface.

16. The tool holder in claim 15, further comprising a cover plate enclosing and retaining the first and second cutting insert holders within the first and second elongated slots.

17. The tool holder in claim 15, further comprising a spring coupled to the actuator arm configured to bias the actuator arm to maintain a neutral position between the first and second pivoting positions.

18. The tool holder in claim 15, wherein the first and second elongated cutting insert holders are pivotally secured to the tool holder body within the first and second elongated slots using first and second pivot bolts and pivot bushings.

19. The tool holder in claim 15, further comprising first and second spring plungers disposed adjacent to the first and second elongated cutting insert holders operable to urge the first and second elongated cutting insert holders to return from their respective pivoted withdrawn positions to respective cutting positions.

20. The tool holder in claim 15, further comprising:
hardened stops disposed adjacent to the first and second elongated slots on either side of each of the first and second cutting insert holders; and
means to make minute adjustments to the position of the first and second cutting insert holders within the elongated slots.
